(19) United States
(12) Patent Application Publication
(10) Pub. No.: US 2021/0141567 A1
(43) Pub. Date: May 13, 2021

(54) MEMORY CONTROLLER, METHOD EXECUTED BY MEMORY CONTROLLER, AND APPARATUS

(71) Applicant: CANON KABUSHIKI KAISHA, Tokyo (JP)

(72) Inventors: Daisuke Shiraishi, Tokyo (JP); Motohisa Ito, Chiba (JP)

(21) Appl. No.: 17/072,400

(22) Filed: Oct. 16, 2020

(30) Foreign Application Priority Data
Nov. 8, 2019 (JP) 2019-203509

(51) Int. Cl. G06F 3/06

(52) U.S. Cl. CPC G06F 3/0659; G06F 3/0673; G06F 3/0658; G06F 3/061

(57) ABSTRACT

A storage unit stores a memory access request to a DRAM. A deciding unit decides, based on a predetermined criteria, an issuance order of stored memory access requests. An issuance unit issues a command to the DRAM based on the decided issuance order. A determination unit, when the issuance unit issues a command of a first memory access request to the DRAM, selects, in accordance with the issuance order, a second memory access request that will next issue a command to the same bank as a bank where the first memory access request issues a command, and then determine whether the first and second memory access request target the same page. The issuance unit issues a command of the first memory access request without an auto precharge if determination unit determines that the same page is targeted.

### BACKGROUND OF THE INVENTION

### Field of the Invention

The present invention relates to a memory controller, a method executed by a memory controller, and an apparatus.

### Description of the Related Art

As a main storage apparatus of a computer system, DRAM (Dynamic Random Access Memory) is typically used. In conjunction with an increase in the sophistication of functions and performance of computer systems, there are increasing demands for higher DRAM performance, and various memory controllers are proposed for maximizing such performance.

In a case where memory access to a plurality of banks of DRAM is controlled independently, issuance timings of a plurality of commands may overlap. Because the plurality of commands cannot be issued simultaneously, some command issuances need to be delayed, thereby causing memory utilization efficiency to become lower. In relation to this, a design is made in which a read/write command with an auto precharge, which precharges an accessed page after a memory access, is used to reduce a number of command issuances in order to decrease a probability that the issuance timings of the plurality of commands overlap.

In Japanese Patent Laid-Open No. 2007-249837, pages accessed by a current memory access and a next memory access are compared, and then a read/write command with an auto precharge is issued in a case where the pages are different. On the other hand, a read/write command without an auto precharge is issued in a case where the pages are the same.

### SUMMARY OF THE INVENTION

In recent years, for memory controllers, improvement in memory utilization efficiency and latency reduction has been achieved by a reorder function which rearranges memory access requests received from a bus based on a priority order of the memory access requests and a DRAM state.

According to a method described in Japanese Patent Laid-Open No. 2007-249837, pages to be accessed by a current memory access and a memory access received next from a bus are being compared, and the rearrangement of the memory access requests by the reorder function is not being considered. Therefore, in a case where memory access requests are rearranged by a reorder function, read/write commands with an auto precharge may be issued even though there is subsequently a memory access for the same page. Similarly, read/write without an auto precharge may be issued even though there is subsequently a memory access for a different page. In this way, there is a possibility that the memory utilization efficiency will become lower.

An embodiment of the present invention provides a technique by which it is possible to increase the memory utilization efficiency in the memory controller in which the reorder function is implemented.

As a means for solving the above problems, an embodiment of the present invention comprises the following configuration.

An embodiment of the present invention provides a memory controller configured to be connected to a DRAM, the memory controller comprising: a storage unit configured to store a memory access request to the DRAM; a deciding unit configured to decide, based on a predetermined criteria, an issuance order of memory access requests stored in the storage unit; an issuance unit configured to issue a command to the DRAM based on the issuance order decided by the deciding unit; and a determination unit configured to, when the issuance unit issues a command of a first memory access request to the DRAM, select, in accordance with the issuance order decided based on the predetermined criteria, a second memory access request that will issue, next to the issuance target memory access request, a command to the same bank as a bank where the first memory access request issues a command, and then determine whether the first memory access request and the second memory access request target the same page, wherein the issuance unit, in a case where the determination unit determines that the same page is targeted, issues a command of the first memory access request without an auto precharge.

An embodiment of the present invention provides a method executed by a memory controller connected to a DRAM, the memory controller including a storage unit configured to store a memory access request to the DRAM, the method comprising: deciding, based on a predetermined criteria, an issuance order of memory access requests stored in the storage unit; issuing a command to the DRAM based on the decided issuance order when a command of a first memory access request is issued to the DRAM, selecting, in accordance with the issuance order decided based on the predetermined criteria, a second memory access request that will issue, next to the issuance target memory access request, a command to the same bank as a bank where the first memory access request issues a command, and then determining whether the first memory access request and the second memory access request target the same page, wherein the issuing, in a case where the same page is determined to be targeted, issues a command of the first memory access request without an auto precharge.

An embodiment of the present invention provides an apparatus comprising: a DRAM; and a memory controller configured to be connected to the DRAM, wherein the memory controller comprises: a storage unit configured to store a memory access request to the DRAM; a deciding unit configured to decide, based on a predetermined criteria, an issuance order of memory access requests stored in the storage unit; an issuance unit configured to issue a command to the DRAM based on the issuance order decided by the deciding unit; and a determination unit configured to, when the issuance unit issues a command of a first memory access request to the DRAM, select, in accordance with the issuance order decided based on the predetermined criteria, a second memory access request that will issue, next to the issuance target memory access request, a command to the same bank as the bank where the first memory access request issues a command, and then determine whether the first memory access request and the second memory access request target the same page, wherein the issuance unit, in a case where the determination unit determines the same page to be targeted, issues a command of the first memory access request without an auto precharge.

An embodiment of the present invention increases the memory utilization efficiency in the memory controller in which the reorder function is implemented.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a view illustrating a hardware configuration of an image processing apparatus which comprises a memory controller according to an embodiment.

FIG. 2 is a block diagram illustrating functions and configurations of the memory controller in FIG. 1 and components connected thereto.

FIG. 3 is a data structure diagram illustrating an entry that constitutes a memory access request storage unit of FIG. 2.

FIG. 4 is a configuration diagram of a storage unit control signal in the present embodiment.

FIG. 5 is a block diagram illustrating a function and a configuration of a memory access request issuance order deciding unit of FIG. 2.

FIG. 6 is a flowchart illustrating a page determination algorithm in a page determination unit of FIG. 2.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In embodiments, even in a case where memory access requests are rearranged by a reorder function in a memory controller of a DRAM, an auto precharge of the read/write command is controlled by, based on an actual issuance order of memory access requests after the rearrangement, comparing the memory access request which is to next access the same bank and a page. This makes it possible to reduce unnecessary auto precharge and increase memory utilization efficiency.

FIG. 1 is a view illustrating a hardware configuration of an image processing apparatus 200 which comprises a memory controller 100 according to an embodiment. The image processing apparatus 200 is a small electronic device, for example, a smartphone or the like. The image processing apparatus 200 has a function of capturing an image of a subject and then displaying the captured image on a monitor in real time. Note that a case when the memory controller 100 according to the embodiment is installed in the image processing apparatus 200 is described below. However, it will be clear to the skilled person who came into contact with the present specification that the memory controller 100 can be widely installed electronic devices such as digital cameras and the like.

The image processing apparatus 200 comprises at least an image capturing unit 201, a DRAM 110, an image processing unit 202, a system bus 204, the memory controller 100, a display unit 205 and a bus master 120.

The image capturing unit 201 obtains a captured image of a subject by capturing the subject. The image capturing unit 201 in the present embodiment can obtain not only a still image, but also a moving image, and outputs each frame image forming the moving image at a predetermined image capturing timing. The image processing unit 202 performs desired image processing on an image obtained by the image capturing unit 201. The image processing is general processing such as luminance correction and gamma correction, and so a detailed description thereof will be omitted.

The DRAM 110 is a synchronized memory that is used as a work memory for temporarily storing captured images obtained by the image capturing unit 201 or captured images that have undergone the image processing by the image processing unit 202. The memory controller 100 is an interface that controls access to the DRAM 110. A configuration and operation of the memory controller 100 will be described later.

The display unit 205 is a monitor that displays, at a predetermined display timing, an image that has undergone the image processing by the image processing unit 202. Data is exchanged between the above processing units via the system bus 204 under arbitration of the bus master 120. The memory controller 100 controls access to the DRAM 110 so that the captured image obtained at the predetermined image capturing timing by the image capturing unit 201 goes under the image processing by the image processing unit 202 and is displayed at the predetermined display timing on the display unit 205.

FIG. 2 is a block diagram illustrating functions and configurations of the memory controller 100 in FIG. 1 and components connected thereto. The memory controller 100 is connected to the DRAM 110 and the bus master 120. The bus master 120 transmits a memory access request including address information and write data, if there is a write request, to the memory controller 100. The memory controller 100 generates a DRAM command based on the memory access request received from the bus master 120 and transmits it to the DRAM 110. Also, data transfer with the DRAM 110 is performed based on the transmitted DRAM command. When the DRAM 110 receives a read/write command with an auto precharge, the DRAM 110, after executing the read/write, precharges an accessed page. The read/write command with an auto precharge is, for example, a write auto precharge or a read auto precharge in a DDR3 SDRAM. The memory controller 100 and the DRAM 110 may be arranged on separate semiconductor chips or may be arranged on a single semiconductor chip. Alternatively, the DRAM 110 may be a plurality of memory devices arranged on separate semiconductor chips.

The DRAM 110 includes a plurality of banks, various kinds of decoders, an input/output sense amplifier, and a data bus buffer. In each bank, DRAM cells, which are storage elements, are arranged in a matrix. The DRAM 110 may be a DRAM memory device which complies with the DDR3 SDRAM or a LPDDR4.

The memory controller 100 controls the DRAM 110 by providing a command (a DRAM command) and an address to the DRAM 110. The memory controller 100 transmits write data to the DRAM 110 and receives data read out from the DRAM 110. The memory controller 100 and the DRAM 110 operate in synchronization with a common clock signal supplied from the system bus 204. For the sake of descriptive convenience, functions related to issuance of commands of the memory controller 100 will be mainly described below, and description of other functions, such as the controlling of a data line (DQ), of the memory controller 100 will be omitted.

The memory controller 100 comprises a memory access request storage unit 101, a memory access request issuance order deciding unit 102, a page determination unit 103, and a DRAM command issuance unit 104.

First, the memory access request storage unit 101 will be described. The memory access request storage unit 101 is a buffer which holds the memory access request which is an access request to the DRAM 110. The memory access request storage unit 101 is configured by m (m≥2) entries, and an entry number, from 0 to m−1, is added to each entry. Note that the present embodiment is not limited to specific number m.

FIG. 3 is a data structure diagram illustrating an entry 1011 that configures the memory access request storage unit 101 of FIG. 2. In the present embodiment, the memory access request storage unit 101 comprises m units of the entry 1011 shown in FIG. 3. As illustrated in FIG. 3. the entry 1011 comprises a request type field, a target bank field, a target page field, a DRAM command count field and an index field.

Information stored in each field is as follows.

### (a) Request Type Field

This field indicates the type of the memory access request stored in the entry.

WRITE: the memory access request is write (writing of the data)

READ: the memory access request is read (reading of the data)

### (b) Target Bank Field

A bank number of a bank to be accessed by the memory access request stored in the entry.

### (c) Target Page Field

A page number of a page to be accessed by the memory access request stored in the entry.

### (d) DRAM Command Count Field

How many DRAM commands are to be performed by the memory access request stored in the entry.

### (e) Index Field

This field indicates a DRAM command number (0, . . . , how many DRAM commands there are −1) to be issued next among the DRAM commands which are executed by the memory access request stored in the entry.

In a case where the memory access request is stored newly in the memory access request storage unit 101, the memory access request stored newly is stored in an entry continuing from the end of the memory access requests which are already stored. In a case where a memory access request is read out from the memory access request storage unit 101, it is possible to read out from an arbitrary entry.

Operation of the memory access request storage unit 101 is described using Table 1.

TABLE 1

| | | After | |
|---|---|---|---|
| | | Storage of | After |
| | | Memory Access | Purge of |
| Entry | Current State | Request | Entry |
| 0 | REQ00 | REQ00 | REQ00 |
| 1 | REQ01 | REQ01 | REQ02 |
| 2 | REQ02 | REQ02 | REQ03 |
| 3 | Empty | REQ03 | Empty |
| 4 | Empty | Empty | Empty |
| . . . | . . . | . . . | . . . |
| m − 1 | Empty | Empty | Empty |

In Table 1, REQ00, REQ01, REQ02 and REQ03 are IDs for uniquely identifying memory access requests stored in the memory access request storage unit 101. Assume that the state of the memory access request storage unit 101 is in a state indicated in the column “Current State” of Table 1. That is, REQ00, REQ01, and REQ02 are stored in entries 0 to 2, respectively, of the memory access request storage unit 101. On the other hand, a memory access request is not stored from entry 3 to the final entry m−1, and these entries are empty.

Here, the operation for storing REQ03 which is a new memory access request will be described next. A storage destination entry of the new memory access request is an entry that continues from the end of the memory access requests which are already stored in the memory access request storage unit 101. Therefore, in a case where REQ03 is to be added and stored in the state indicated by the column “Current State” of Table 1, REQ03 will be stored in entry 3. The state after the storage of REQ03 is indicated in a column “After Storage of Memory Access Request” of Table 1. After the storage of REQ03, a memory access request is stored in each entry from entries 0 to 3 as indicated by the column “After Storage of Memory Access Request” of Table 1.

Next, a storage unit control signal which is inputted to the memory access request storage unit 101 will be described below. FIG. 4 is a configuration diagram of a storage unit control signal 1021 in the present embodiment. The storage unit control signal 1021 comprises an entry number field, a purge field, and an update field.

Information indicated by each field is as follows.

### (a) Entry Number Field

This field indicates the control target entry of the memory access request storage unit 101.

### (b) Purge Field

This field indicates that the entry of the memory access request storage unit 101 indicated in the entry number field will be purged.

1′b1: purge; 1′b0: no purge operation

### (c) Update Field

This field indicates that the entry of the memory access request storage unit 101 indicated in the entry number field will be updated.
1′b1; the value of the index field will be incremented by 1; 1′b0: no updating operation will be performed

In a case where the update field of the storage unit control signal 1021 is set to “1”, the memory access request storage unit 101 adds “1” to the value of the index field of the entry which is indicated in the entry number field. Also, in a case where the purge field is set to “1”, the entry indicated in the entry number field is purged, and simultaneously, the memory access requests which are stored in subsequent entries are moved one at a time into the entry that became empty. Assume that REQ01 of the entry 1 has been purged from the state indicated by the column “After Storage of Memory Access Request” of Table 1. After the purge, each of the memory access requests stored in the entry 2 and the subsequent entries moves up by one, in ascending order, to an entry of a smaller number. A state after purging REQ01 of the entry 1 is indicated in a column, “After Purge of Entry”, in Table 1.

Returning to FIG. 2, the memory access request issuance order deciding unit 102 will be described. The memory access request issuance order deciding unit 102 is able to refer all of the stored memory access requests stored in the memory access request storage unit 101. The memory access request issuance order deciding unit 102 decides an order of issuance to the DRAM 110 of the stored memory access requests stored in the memory access request storage unit 101 based on at least one of the priority order of the memory access requests and the state of the DRAM 110. Then, the memory access request to be issued first among the stored memory access requests is outputted to the DRAM command issuance unit 104 as an issuance target memory access request.

The memory access request issuance order deciding unit 102 decides the issuance order independently of page determination in the page determination unit 103 described later. The DRAM command issuance unit 104 is influenced by a determination result of the page determination unit 103, and because the memory access request issuance order deciding unit 102 does not receive the determination result, it is also not influenced.

The issuance order decided by the memory access request issuance order deciding unit 102 is different from an order of registrations of memory access requests to the memory access request storage unit 101. As described above, memory access requests are registered so as to be arranged chronologically in the memory access request storage unit 101. In contrast to this, when memory access requests are issued, the memory access requests are not selected in order from the oldest to newest, but rather the memory access request is issued from a particular entry in the issuance order decided by the memory access request issuance order deciding unit 102.

Inputs to the memory access request issuance order deciding unit 102 are the stored memory access request stored by the memory access request storage unit 101 and the DRAM command issuance state outputted by the DRAM command issuance unit 104.

The DRAM command issuance state is a signal indicating an issued DRAM command and information related to that DRAM command, and the DRAM command issuance state includes a signal representing the states listed below.
(a) cmd: an issued DRAM command
(b) bank: a target bank of the issued DRAM command
(c) page: a target page of the issued DRAM command

The output of the memory access request issuance order deciding unit 102 is the issuance target memory access request, the storage unit control signal, and the DRAM state. The issuance target memory access request is the memory access request issued first among the stored memory access requests. The storage unit control signal is a control signal instructing a purge or an update of an entry to the memory access request storage unit 101. The DRAM state is the state of the DRAM managed by the memory access request issuance order deciding unit 102.

FIG. 5 is a block diagram illustrating functions and configurations of the memory access request issuance order deciding unit 102 of FIG. 2. The memory access request issuance order deciding unit 102 comprises a DRAM state management unit 1022 and an issuance order deciding unit 1023.

The DRAM state management unit 1022 manages a DRAM state based on a value of the DRAM command issuance state. The DRAM state managed by the DRAM state management unit 1022 includes at least the states indicated next.

(a) ref(k)

This state indicates whether bank k is undergoing a refresh operation.

1′b1: undergoing a refresh operation

1′b0: undergoing a non-refresh operation

(b) pcmd

A request type of the DRAM command that was issued immediately before.

WRITE: the DRAM command is a data write operation

READ: the DRAM command is a data read operation

(c) padd(k)

The page address at which the bank k is open

(d) bst(k)

This state indicates the state of bank k

1′b1: the bank k is in a state in which the page is opened

1′b0: the bank k is in a state in which the page is closed

The DRAM state management unit 1022 will be described in further detail. First, the operation of ref(k) will be described. When the DRAM command issuance unit 104 issues an REF command to bank k, the DRAM state management unit 1022 sets 1′b1 in ref(k). After the refresh operation time has elapsed, the DRAM state management unit 1022 sets the value of ref(k) to 1′b0. For example, assume that the DRAM command issuance unit 104 has issued an REF command to bank 0. At this time, the value of the DRAM command issuance state is changed to:

(cmd, bank, page)==(REF, 0, −)

Here, “−” is assumed to represent “don't care”. Based on this change, the DRAM state management unit 1022 recognizes the start of the refresh operation in relation to bank 0. 1′b1 is set to ref(0) upon recognition of the start of the refresh operation.

pcmd holds the request type that was issued immediately before. For example, it is assumed that the DRAM command issuance unit 104 has issued a WR command to page 0 of bank 0. At this time, the DRAM command issuance state is changed to:

(cmd, hank, page)==(WR, 0, 0)

Based on this change, the DRAM state management unit 1022 will recognize the issuance of the WR command, and will set WRITE as the request type of the WR command in pcmd.

padd(k) and bst(k) each indicate the state of bank k. When the DRAM command issuance unit 104 issues an ACT command to page p of bank k, the DRAM state management unit 1022 recognizes that page p of bank k is in an open state. Then, the following operations are performed.

Set p in (a) padd(k)

Set 1′b1 (available) in (b) bst(k)

Meanwhile, when the DRAM command issuance unit 104 issues a PRE command or the read/write command with an auto precharge to page p of bank k, the DRAM state management unit 1022 recognizes that bank k is in a closed state. Then, the following operation is performed.
Set 1′b0 in (a) bst(k)
   Note that the value of padd(k) does not change.

For example, assume that the DRAM command issuance unit 104 has issued an ACT command on page 5 of bank 0. At this time, the DRAM command issuance state is changed to:

(cmd, hank, page)==(ACT, 0, 5)

Based on this change, the DRAM state management unit 1022 will execute the next operations.

Set 5 in (a) padd(0)

Set 1′b1 in (h) bst(0)

Conversely, it is assume that the DRAM command issuance unit 104 has issued a PRE command to page 5 of bank 0. At this time, the DRAM command issuance state is changed to:

(cmd, hank, page)==(PRE, 0, 5)

Based on this change, the DRAM state management unit 1022 will execute the next operation.

Set 1′b0 in (a) bst(0)

The DRAM state managed by the DRAM state management unit 1022 is outputted to an issuance order deciding unit 1023 and the page determination unit 103.

Next, the issuance order deciding unit 1023 will be described. The issuance order deciding unit 1023 decides an issuance order of stored memory access request according to the next DRAM state criteria.
(A) Difference between the type of the DRAM command corresponding to stored memory access request that is the target of the decision and the type of the DRAM command that was issued immediately before.
(B) Whether the target bank of the stored memory access request that is the target of the decision is undergoing a refresh operation or not.
(C) Whether the target page of the stored memory access request that is the target of the decision is open or not.

The issuance order deciding unit 1023, when deciding the issuance order of the stored memory access request, may apply the criteria (A) to (C) independently or a plurality of criteria simultaneously. Also, in the present embodiment, in a case where a plurality of the stored memory access requests satisfy the criteria, the memory access request with the smallest entry number among the stored memory access requests satisfying the criteria will be selected. Also, in a case where none of the stored memory access requests satisfy the criteria, the memory access request with the smallest entry number among the stored memory access requests will be selected.

Although, in the present embodiment, the issuance order of the stored memory access request is decided based on the DRAM state, the criteria for deciding the issuance order is not limited to the DRAM state. In another embodiment, the issuance order may be decided based on other criteria such as a priority order given to memory access requests.

Next, a procedure by which the issuance order deciding unit 1023 generates the storage unit control signal 1021 will be described using Table 2.

TABLE 2

| | | | | DRAM | |
|---|---|---|---|---|---|
| | Request | Target | Target | Command | |
| Entry | Type | Bank | Page | Count | Index |
| 0 | WRITE | 0 | 0 | 4 | 0 |
| 1 | WRITE | 0 | 1 | 4 | 0 |
| 2 | READ | 0 | 0 | 8 | 2 |
| 3 | WRITE | 1 | 0 | 4 | 3 |
| 4 | WRITE | 2 | 1 | 4 | 3 |
| 5 | READ | 1 | 0 | 4 | 3 |
| 6 | WRITE | 1 | 0 | 1 | 0 |
| 7 | WRITE | 2 | 0 | 4 | 0 |
| 8 | READ | 2 | 0 | 4 | 0 |
| . . . | | | | | |
| m − 1 | | | | | |

Table 2 indicates the value that each field of the entry 1011 illustrated in FIG. 3 takes for each memory access request. An “Index” column in Table 2 indicates the DRAM command number of the command to be issued next among DRAM commands which are to be executed according to the memory access request stored in the entry. For example, the value of “Index” column is 0 in entry 0 in Table 2. This indicates that the DRAM command positioned at the 0-th position, that is at the head of the DRAM commands executed by the memory access request, is to be issued next. When the last DRAM command executed by the memory access request is issued, the corresponding memory access request processing is completed. Therefore, the corresponding entry is purged from the memory access request storage unit 101. On the other hand, when the DRAM command is issued, the entry corresponding to the memory access request storage unit 101 is updated. However, in a case where the last DRAM command is issued, it is not necessary to update the corresponding entry. Whether the issued DRAM command is the last DRAM command is determined by the value of the DRAM command count field of the entry 1011 and the value of the index field. When the DRAM command issuance state indicates a DRAM command issuance in the state of (the value of index field=the value of the DRAM command count field−1), it is indicated that the last DRAM command has been issued. Therefore, when the DRAM command issuance state indicates DRAM command issuance and (the value of index field=the value of the DRAM command count field−1), the storage unit control signal 1021 is generated to purge the entry of the corresponding memory access request. On the other hand, in a case where the DRAM command issuance state indicates DRAM command issuance and (the value of index field the value of the DRAM command count field−1), the storage unit control signal 1021 is generated to update the entry of the corresponding memory access request.

The operation of the page determination unit 103 will be described. The page determination unit 103, when the DRAM command issuance unit 104 issues an issuance target memory access request command to the DRAM 110, selects the stored memory access request that will issue, next to the issuance target memory access request, a command to the same bank as a bank where the issuance target memory access request issues a command, according to the issuance order decided based on the same criteria as the criteria used by the memory access request issuance order deciding unit 102. The page determination unit 103 determines whether the issuance target memory access request and selected memory access request target the same page. The page determination unit 103, in a case where there is the plurality of the stored memory access requests which target the same bank as the bank targeted by the issuance target memory access request, selects one stored memory access request among the plurality of stored memory access requests according to the above issuance order.

FIG. 6 is a flowchart illustrating the page determination algorithm in the page determination unit 103 in FIG. 2. The page determination unit 103, in relation to the issuance target memory access request outputted by the memory access request issuance order deciding unit 102, selects a stored memory access request which will next access the target bank thereof, and determines whether the target page is the same. Then, the page determination unit 103 outputs the determined result to the DRAM command issuance unit 104 as the page determination result.

The page determination unit 103 determines whether a memory access request whose the target bank is the same as the issuance target memory access request outputted by the memory access request issuance order deciding unit 102 is present in the memory access request storage unit 101 (S1031). In a case where there is the corresponding stored memory access request (YES in S1031), the page determination unit 103 determines whether two or more corresponding memory access request are stored (S1032). In a case where there are two or more corresponding stored memory access requests (YES in S1032), the page determination unit 103 selects the memory access request which will be issued next to the issuance target memory access request for the same bank as a bank where the issuance target memory access request is issued, based on the criteria for when the memory access request issuance order deciding unit 102 decides the issuance order (S1033). The page determination unit 103 compares the target page of the selected memory access request and the target page of the issuance target memory access request (S1034). The page determination unit 103 outputs the result of the comparison in S1034 to the DRAM command issuance unit 104 as the page determination result (S1035).

In a case where there is no corresponding stored memory access request in S1031 (NO in S1031), the page determination unit 103 generates a comparison result based on the page control that is designated in a register setting or is predecided (S1037). In a case where there is a high probability that successive memory access requests targeting the same bank will access different pages, for example, the page determination unit 103 generates a comparison result of “the target pages are different” in order to issue a read/write command with an auto precharge. On the other hand, in a case where there is high probability that two memory access requests will access the same page, the page determination unit 103 generates a comparison result of “the target pages are the same” in order to issue a read/write command without an auto precharge.

In a case where there are not two or more relevant stored memory access requests in S1032 (NO in S1032), because there is only one relevant stored memory access request, the page determination unit 103 compares the target page of that only one stored memory access request and the target page of the issuance target memory access request (S1036).

Below, operation of the memory access request issuance order deciding unit 102 and the page determination unit 103 will be described specifically with the two examples of condition A and condition B. Table 2 which illustrates the state of the memory access request storage unit 101 is used for the explanation. Assume that there is no dependency relationship between the respective memory access requests described in Table 2, and that the issuance order can be changed arbitrarily.

Examples are given below. Note that only the information necessary for describing the DRAM state is described.

[Condition A]
Selection criteria of the memory access request issuance order deciding unit 102 are as follows.

(A) The target bank is not undergoing a refresh operation

(B) The DRAM request that is of the same type as the DRAM request that was issued immediately before.

(C) The target page is in an open state
The priority between the criteria is (A)>(B)>(C).
The state of the memory access request storage unit 101 is the state of Table 2.
Assume that the DRAM state is as follows.

(a)

| | |
|---|---|
| ref(0) == 1′b1 | bank 0 is undergoing a refresh operation |
| ref(1) == 1′b0 | bank 1 is undergoing a non-refresh operation |
| ref(2) == 1′b0 | bank 2 is undergoing a non-refresh operation |

(b)

| | |
|---|---|
| pcmd == WRITE | The DRAM command that was issued immediately |
| is WRITE | before |

(c)

| | |
|---|---|
| padd(1) == 0 | bank 1 targets page 0 |
| padd(2) == 1 | bank 2 targets page 1 |

(d)

| | |
|---|---|
| bst(1) == 1 | bank 1 is in a state in which the page is open |
| bst(2) == 1 | bank 2 is in a state in which the page is open |

In Table 2, entries which fulfill all of the selection criteria (A), (B). and (C) are an entry 3, an entry 4, and an entry 6. In a case where a plurality of the stored memory access requests fulfill the criteria, the memory access request issuance order deciding unit 102 selects a memory access with the smallest entry number among the stored memory access request that satisfies the criteria. Therefore, the memory access request issuance order deciding unit 102 selects the entry 3 as the issuance target memory access request. When the entry 3 is selected as the issuance target memory access request, the page determination unit 103 confirms whether a memory access request is present in the stored memory access requests whose target hank is the same as that of the entry 3. Two entries, the entry 5 and the entry 6, correspond here. Therefore, the page determination unit 103 selects, among the entry 5 and the entry 6. the memory access request to be issued next to the target bank of the issuance target memory access request according to the issuance order decided based on selection criteria (A), (B), and (C). The DRAM state, after the DRAM command issuance unit 104 has issued the DRAM command to the entry 3 which is the issuance target memory access request, is shown next.

The DRAM state after the DRAM command is issued to the entry 3:

(a)

| | |
|---|---|
| ref(0) == 1′b1 | bank 0 is undergoing a refresh operation |
| ref(1) == 1′b0 | bank 1 is undergoing a non-refresh operation |
| ref(2) == 1′b0 | bank 2 is undergoing a non-refresh operation |

(b)

| | |
|---|---|
| pcmd == WRITE | The DRAM command that was issued immediately |
| is WRITE | before |

(c)

| | |
|---|---|
| padd(1) == 0 | bank 1 targets page 0 |
| padd(2) == 1 | bank 2 targets page 1 |

(d)

| | |
|---|---|
| bst(1) == 1 | bank 1 is in a state in which the page is open |
| bst(2) == 1 | bank 2 is in a state in which the page is open |

In the DRAM state described above, when the same selection criteria as the memory access request issuance order deciding unit 102 is followed, among the entry 5 and the entry 6, the entry 6 which is the same request type as the DRAM command that was issued immediately before, is selected as an issuance target memory access request. In this way, the page determination unit 103 selects the entry 6 as the memory access request to be issued next to the target bank of the entry 3 based on the DRAM state and the issuance target memory access request. The page determination unit 103 compares the target page of the selected memory access request, entry 6, and the target page of the issuance target memory access request. Because the target page of the entry 3 and the target page of the entry 6 are the same, the page determination unit 103 outputs to the DRAM command issuance unit 104 a comparison result that the issuance target memory access request and the memory access request that will next access the target bank of the issuance target memory access request will access the same page.

[Condition B]
Selection criteria of the memory access request issuance order deciding unit 102 are as follows.

(A) The target bank is not undergoing a refresh operation

(B) The DRAM request that is of the same type as the DRAM request that was issued immediately before.

(C) The target page is in an open state
The priority between the criteria is (A)>(B)>(C).
The state of the memory access request storage unit 101 is the state of Table 2.
Assume that the DRAM state is as follows.

(a)

| | |
|---|---|
| ref(0) == 1′b1 | bank 0 is undergoing a refresh operation |
| ref(1) == 1′b0 | bank 1 is undergoing a non-refresh operation |
| ref(2) == 1′b0 | bank 2 is undergoing a non-refresh operation |

(b)

| | |
|---|---|
| pcmd == WRITE | The DRAM command that was issued immediately |
| is WRITE | before |

(c)

| | |
|---|---|
| padd(1) == 1 | bank 1 targets page 1 |
| padd(2) == 1 | bank 2 targets page 1 |

(d)

| | |
|---|---|
| bst(1) == 1 | bank 1 is in a state in which the page is open |
| bst(2) == 1 | bank 2 is in a state in which the page is open |

Because the only entry that satisfies all of the selection criteria (A), (B), and (C) in Table 2 is the entry 4, the memory access request issuance order deciding unit 102 selects the entry 4 as the issuance target memory access request. When the entry 4 is selected as the issuance target memory access request, the page determination unit 103 confirms whether there is a memory access request in the stored memory access requests whose target hank is the same as that of the entry 4. Two entries, the entry 7 and the entry 8, correspond here. Therefore, the page determination unit 103 selects, among the entry 7 and the entry 8, the memory access request to be issued next to the target bank of the issuance target memory access request according to the issuance order decided based on selection criteria (A), (B), and (C). The DRAM state, after the DRAM command issuance unit 104 has issued the DRAM command to the entry 4 which is the issuance target memory access request, is shown next.

The DRAM state after the DRAM command is issued to the entry 4:

(a)

| | |
|---|---|
| ref(0) == 1′b1 | bank 0 is undergoing a refresh operation |
| ref(1) == 1′b0 | bank 1 is undergoing a non-refresh operation |
| ref(2) == 1′b0 | bank 2 is undergoing a non-refresh operation |

(b)

| | |
|---|---|
| pcmd == WRITE | The DRAM command that was issued immediately |
| is WRITE | before |

(c)

| | |
|---|---|
| padd(1) == 1 | bank 1 targets page 1 |
| padd(2) == 1 | bank 2 targets page 1 |

(d)

| | |
|---|---|
| bst(1) == 1 | bank 1 is in a state in which the page is open |
| bst(2) == 1 | bank 2 is in a state in which the page is open |

In the DRAM state described above, when the same selection criteria as the memory access request issuance order deciding unit 102 is followed, among the entry 7 and the entry 8, the entry 7 which is the same request type as the DRAM command that was issued immediately before, is selected as an issuance target memory access request. In this way, the page determination unit 103 selects the entry 7 as the memory access request to be issued next to the target bank of the entry 4 based on the DRAM state and the issuance target memory access request. The page determination unit 103 compares the target page of the selected memory access request, entry 7, and the target page of the issuance target memory access request. Because the target page of the entry 4 and the target page of the entry 7 are different, the page determination unit 103 outputs to the DRAM command issuance unit 104 a comparison result that the issuance target memory access request and the memory access request that will next access the target bank of the issuance target memory access request will access different pages.

Returning to FIG. 2, the function of the DRAM command issuance unit 104 will be described. The DRAM command issuance unit 104 issues the DRAM command to the DRAM 110 based on the issuance order decided by the memory access request issuance order deciding unit 102. The DRAM command issuance unit 104 issues an issuance target memory access request command without an auto precharge in a case where the page determination unit 103 determines that the target pages are the same, and issues an issuance target memory access request command with an auto precharge in a case where the page determination unit 103 determines that the target pages are not the same.

The DRAM command issuance unit 104 issues the DRAM command to the DRAM 110 based on the issuance target memory access request and the page determination result. First, the DRAM command issuance unit 104 determines whether the DRAM command to be issued is the last DRAM command to be executed by the issuance target memory access request. The DRAM command issuance unit 104 issues the command without an auto precharge in a case where the DRAM command is the last DRAM command and the page determination result outputted by the page determination unit 103 indicates that the memory access request to next access the target bank will access the same page. This command is a read command or a write command, for example. Also, the DRAM command issuance unit 104 issues a command with an auto precharge in a case where the page determination result indicates that the same page will not be accessed. This command is a read auto precharge or a write auto precharge, for example. In a case where the DRAM command is not the last DRAM command, the DRAM command issuance unit 104 issues a command without an auto precharge irrespective of the page determination result.

By the memory controller 100 according to the present embodiment, even if the memory controller 100 has the reorder function, auto precharge of the read/write command is controlled based on the actual issuance order of the memory access requests by comparing the page with that of the memory access request that will next access the same bank. This makes it possible to improve memory utilization efficiency.

The above describes the configuration and operation of the memory controller 100 according to the embodiment. It will be understood by those skilled in the art that the embodiments are illustrative and that various modifications can be made to each component or combination of processes, and that such modifications are within the scope of the present invention.

In the embodiment, a case where the page determination unit 103 receives the DRAM state from the memory access request issuance order deciding unit 102 and performs the selection of the memory access request in accordance with an issuance order decided based on the received DRAM state is described; however, no limitation is made to this, and for example, the page determination unit 103 may receive the issuance order decided by the memory access request issuance order deciding unit 102 as is.

The technical concept according to the present embodiment is applicable to various memory controllers that are connected to the DRAM and issue read/write commands with an auto precharge.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-203509, filed Nov. 8, 2019, which is hereby incorporated by reference herein in its entirety.

What is claimed is:

1. A memory controller configured to be connected to a DRAM, the memory controller comprising:
a storage unit configured to store a memory access request to the DRAM;
a deciding unit configured to decide, based on a predetermined criteria, an issuance order of memory access requests stored in the storage unit;
an issuance unit configured to issue a command to the DRAM based on the issuance order decided by the deciding unit; and
a determination unit configured to, when the issuance unit issues a command of a first memory access request to the DRAM, select, in accordance with the issuance order decided based on the predetermined criteria, a second memory access request that will issue, next to the issuance target memory access request, a command to the same bank as a bank where the first memory access request issues a command, and then determine whether the first memory access request and the second memory access request target the same page, wherein
the issuance unit, in a case where the determination unit determines that the same page is targeted, issues a command of the first memory access request without an auto precharge.

2. The memory controller according to claim 1, wherein the predetermined criteria includes at least one of a priority order of memory access requests and a state of the DRAM.

3. The memory controller according to claim 2, wherein
the deciding unit decides the issuance order based on at least a state of the DRAM; and
the state of the DRAM includes at least one of:
(1) whether a type of a command corresponding to a memory access request that is a decision target and a type of a command issued immediately before are the same or different;
(2) whether a bank that is a target of a memory access request that is a decision target is undergoing a refresh operation; and
(3) whether a page that is a target of a memory access request that is a decision target is open;

4. The memory controller according to claim 1, wherein the determination unit, in a case where a plurality of memory access requests targeting the same bank as a bank targeted by the first memory access request are stored in the storage unit, selects, from among the plurality of memory access requests that are stored, the second memory access request in accordance with the issuance order decided based on the predetermined criteria.

5. The memory controller according to claim 1, wherein the issuance unit, in a case where the determination unit determines that the same page is not targeted, issues a command of the first memory access request with an auto precharge.

6. The memory controller according to claim 5, wherein the command with an auto precharge is a read auto precharge or a write auto precharge.

7. The memory controller according to claim 1, wherein the deciding unit decides the issuance order independently of the determination by the determination unit.

8. The memory controller according to claim 1, wherein
the storage unit includes a plurality of entries, each configured to store a memory access request; and
the storage unit is configured to be able to read out a memory access request from an arbitrary entry.

9. The memory controller according to claim 1, wherein the issuance order decided by the deciding unit is different from a registration order of memory access requests to the storage unit.

10. A method executed by a memory controller connected to a DRAM, the memory controller including a storage unit configured to store a memory access request to the DRAM, the method comprising:
deciding, based on a predetermined criteria, an issuance order of memory access requests stored in the storage unit;
issuing a command to the DRAM based on the decided issuance order
when a command of a first memory access request is issued to the DRAM, selecting, in accordance with the issuance order decided based on the predetermined criteria, a second memory access request that will issue, next to the issuance target memory access request, a command to the same bank as a bank where the first memory access request issues a command, and then determining whether the first memory access request and the second memory access request target the same page, wherein
the issuing, in a case where the same page is determined to be targeted, issues a command of the first memory access request without an auto precharge.

11. An apparatus comprising:
a DRAM; and
a memory controller configured to be connected to the DRAM, wherein
the memory controller comprises:
a storage unit configured to store a memory access request to the DRAM;
a deciding unit configured to decide, based on a predetermined criteria, an issuance order of memory access requests stored in the storage unit;
an issuance unit configured to issue a command to the DRAM based on the issuance order decided by the deciding unit; and
a determination unit configured to, when the issuance unit issues a command of a first memory access request to the DRAM, select, in accordance with the issuance order decided based on the predetermined criteria, a second memory access request that will issue, next to the issuance target memory access request, a command to the same bank as the bank where the first memory access request issues a command, and then determine whether the first memory access request and the second memory access request target the same page, wherein
the issuance unit, in a case where the determination unit determines the same page to be targeted, issues a command of the first memory access request without an auto precharge.
